(19) United States
(12) Patent Application Publication
(10) Pub. No.: US 2011/0054827 A1
(43) Pub. Date: Mar. 3, 2011

(54) TEST APPARATUS AND METHOD FOR MODULATED SIGNAL

(75) Inventors: Masahiro Ishida, Tokyo (JP); Daisuke Watanabe, Tokyo (JP); Toshiyuki Okayasu, Tokyo (JP)

(73) Assignee: Advantest Corporation, a Japanese Corporation, Tokyo (JP)

(21) Appl. No.: 12/548,399

(22) Filed: Aug. 26, 2009

(51) Int. Cl. G06F 19/00

(52) U.S. Cl. 702/125

(57) ABSTRACT

A test apparatus tests a modulated signal under test received from a DUT. A cross timing data generating unit generates cross timing data which indicates a timing at which the level of the signal under test crosses each of multiple thresholds. An expected value data generating unit generates timing expected value data which indicates a timing at which an expected value waveform of the signal under test crosses each of the multiple thresholds when the expected value waveform is compared with each of the multiple thresholds. A timing comparison unit compares the cross timing data with the timing expected value data.

### BACKGROUND OF THE INVENTION

1. Field of the Invention

The present invention relates to a test apparatus.

2. Description of the Related Art

In conventional digital wired communication, a binary transmission method using time division multiplexing (TDM) has been the mainstream. In this case, high-capacity transmission has been realized by parallel high-speed transmission. In order to overcome the physical limitations on parallel transmission, high-speed serial transmission is performed at a data rate of several Gbps to 10 Gbps or more using a high-speed interface (I/F) circuit. However, the data rate acceleration also has a limit, leading to a problem of BER (Bit Error Rate) degradation due to high-frequency loss or reflection in the transmission line.

On the other hand, with the digital wireless communication method, multi-bit information imposed on a carrier signal is transmitted and received. That is to say, the data rate is not directly limited by the carrier frequency. For example, in QAM (Quadrature Amplitude Modification), which is the basic quadrature modulation/demodulation method, quadrature transmission is provided using a single channel. Furthermore, 64-QAM provides 64-value transmission using a single carrier. That is to say, such a multi-modulation method raises the transmission capacity without raising the carrier frequency.

Also, such a modulation/demodulation method can also be applied to wired communication in the same way as with wireless communication. Such a modulation/demodulation method has begun to be applied as the PAM (Pulse Amplitude Modulation) method, QPSK (Quadrature Phase Shift Keying) method, or DQPSK (Differential QPSK) method. In particular, from the cost perspective, it is important to increase the information carried by a single optical fiber. This has shifted the technology trend from binary TDM to transmission using such digital modulation.

In the near future, such a digital modulation/demodulation method has the potential to be applied to a wired interface between devices such as memory, SoC (System On a Chip), etc. However, at the present time, there is no known multi-channel test apparatus which is capable of testing such devices for mass production.

Mixed test apparatuses and RF (Radio Frequency) test modules are known, which test a conventional wireless communication device. However, each conventional wireless communication device has a single or several I/O (input/output) communication ports (I/O ports), and thus conventional test apparatuses and test modules include only several communication ports. Accordingly, it is difficult to employ such a test apparatus or a test module to test a device, such as memory, having from tens of to a hundred or more I/O ports.

Furthermore, with the conventional test apparatuses for RF signals, signals output from a DUT (Device Under Test) are A/D (analog/digital) converted, and large amounts of data thus obtained are subjected to signal processing (including software processing) so as to perform expected value judgment. This leads to a long testing time.

Furthermore, digital pins included in conventional test apparatuses are provided, basically assuming that a binary signal (in some cases, a three-value signal further including the high-impedance state (Hi-Z)) is to be tested. That is to say, conventional test apparatuses including such digital pins have no demodulation function for a digitally modulated signal.

In a case in which all the I/O ports of a device such as memory, MPU (Micro Processing Unit), etc., are configured using the digital modulation method, such a single device has from tens of to a hundred or more I/O ports. Accordingly, there is a need to test such hundreds of I/O ports at the same time. That is to say, there is a need to provide a test apparatus having thousands of channels of I/O ports for digitally modulated/demodulated signals. Furthermore, real-time testing at the hardware level is required in all steps due to the CPU resource limits of the test apparatus.

In addition, it is highly useful for the manufacturers to employ a test apparatus which is capable of real-time testing of test signals modulated using various methods such as amplitude modulation (AM), frequency modulation (FM), amplitude shift keying (ASK), phase shift keying (PSK), etc.

### SUMMARY OF THE INVENTION

The present invention has been made in view of such a situation. Accordingly, it is an exemplary purpose of an embodiment thereof to provide a test apparatus a test method which is capable of testing a modulated signal under test at high speed.

An embodiment of the present invention relates to a test apparatus which tests a modulated signal under test received from a device under test. The test apparatus comprises: a cross timing measurement unit which generates cross timing data which indicates a timing at which the level of the signal under test crosses each of multiple thresholds; an expected value data generating unit which generates timing expected value data that indicates a timing at which an expected value waveform of the signal under test crosses each of the multiple thresholds when the expected value waveform is compared with each of the multiple thresholds; and a comparison unit which compares the cross timing data with the timing expected value data.

With such an embodiment, the quality of a device under test and the waveform quality of a signal under test can be evaluated based upon a timing at which the level of the signal under test changes, instead of a baseband signal obtained by demodulating the signal under test.

Another embodiment of the present invention also relates to a test apparatus. The test apparatus comprises: a cross timing measurement unit which generates cross timing data which indicates a timing at which the level of the signal under test crosses each of multiple thresholds; and a waveform reconstruction unit which receives the cross timing data for each threshold, and reconstructs the waveform of the signal under test by performing interpolation in the time direction and in the amplitude direction.

With such an embodiment, time domain analysis, frequency domain analysis, and modulation analysis can be performed by means of the test apparatus alone without the need to use a high-cost spectrum analyzer, digitizer, or the like.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram which shows a configuration of a test apparatus according to a first embodiment of the present invention;

FIG. 2 is a circuit diagram which shows an example configuration of a latch array;

FIG. 3A is a time chart which shows the operation of a cross timing data generating unit, and FIG. 3B is a diagram which shows an expected value waveform, multiple thresholds, and timing expected value data;

FIGS. 4A through 4C are diagrams which show examples of comparison processing performed by a timing comparison unit;

FIG. 5 is a block diagram which shows a configuration of a test apparatus according to a second embodiment of the present invention;

FIG. 6 is a diagram which shows sampling of various modulated waves performed by the cross timing data generating unit;

FIG. 7 is a diagram which shows a waveform reconstructed by a waveform reconstruction unit;

FIG. 8 is a block diagram which shows a configuration of a part of a test apparatus according to a first modification;

FIG. 9 is a block diagram which shows a configuration of a test apparatus according to a second modification; and

FIG. 10 is a conceptual diagram which shows comparison processing for making a comparison between amplitude expected value data and judgment data, performed by a level comparison unit.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

The test target to be tested by a test apparatus according to an embodiment is a device under test (DUT) including a transmission/reception interface for digitally modulated digital data. That is to say, a pattern signal is digitally modulated, and the pattern signal thus digitally modulated is supplied to the DUT. Furthermore, the digitally modulated data output from the DUT is compared with an expected value so as to perform quality judgment. The test apparatus may include a waveform analysis function for the data thus digitally modulated, a function of generating a constellation map, etc., in addition to the quality judgment function.

Digital modulation includes APSK (amplitude phase shift keying), QAM (quadrature amplitude modulation), QPSK (quadrature phase shift keying), BPSK (binary phase shift keying), and FSK (frequency shift keying), etc. The DUT is assumed to be a device having a multi-channel I/O port such as memory or MPU. However, the DUT is not restricted in particular.

### First Embodiment

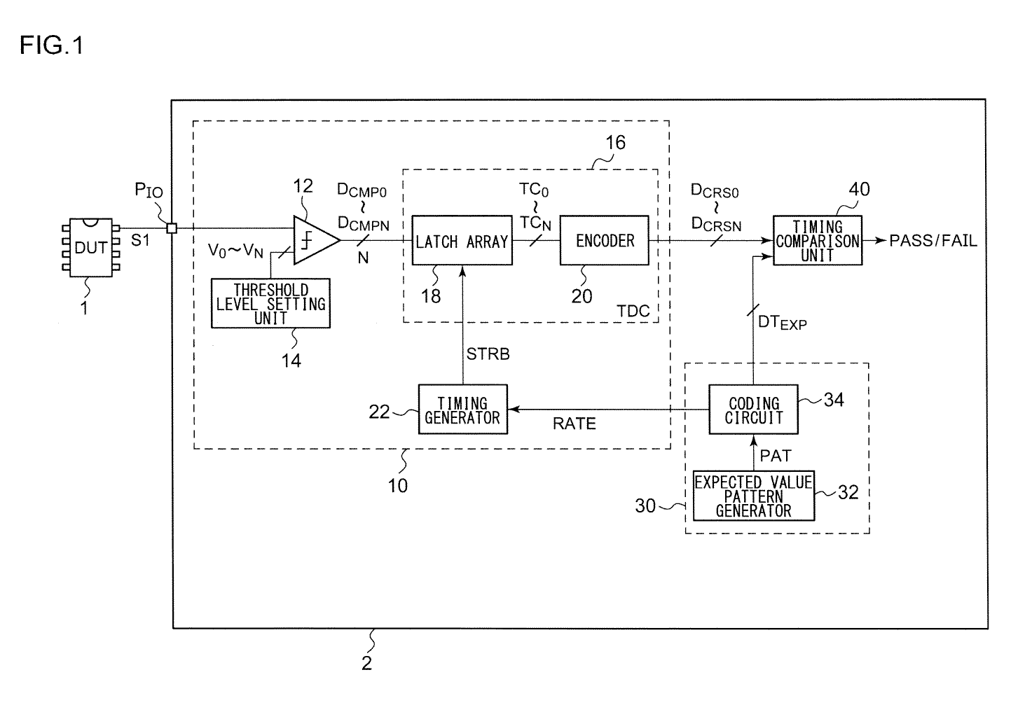

FIG. 1 is a block diagram which shows a configuration of a test apparatus 2 according to a first embodiment of the present invention. The test apparatus 2 shown in FIG. 1 includes multiple I/O terminals P_{IO} provided in increments of I/O ports of a DUT 1. Each of the I/O terminals P_{IO} of the test apparatus 2 is connected to a corresponding I/O port of the DUT 1 via a transmission path, and receives a modulated signal under test S1 from the DUT 1 as an input signal. The number of I/O ports P_{IO} is not restricted in particular. In a case in which the DUT 1 is memory or an MPU, tens of to one hundred or more I/O ports P_{IO} are provided. However, to facilitate understanding and for simplification of explanation, only a single I/O terminal P_{IO} and the related block are shown.

The test apparatus 2 includes three function blocks, i.e., a cross timing data generating unit 10, an expected value data generating unit 30, and a timing comparison unit 40, for each I/O terminal P_{IO}. Step-by-step description will be made below regarding these function blocks.

(1-a) Cross Timing Data Generating Unit The cross timing data generating unit 10 generates cross timing data D_{CRS} which indicates the timing at which the signal under test S1 crosses each of multiple threshold values V₀ through V_{N} (N represents an integer).

Specifically, the cross timing data generating unit 10 includes a multi-value comparator 12, a threshold level setting unit 14, a time-to-digital converter 16, and a real-time timing generator (which will also be referred as a “timing generator”) 22. The real-time timing generator 22 may be provided for each cross timing data generator 10. Also, a single real-time timing generator 22 may be shared by multiple cross timing data generating units 10.

The multi-value comparator 12 compares the level of the signal under test S1 with each of the multiple thresholds V₀ through V_{N}, and generates comparison data D_{CMP0} through D_{CMPN} which represent comparison results in increments of the thresholds V₀ through V_{N}. For example, the i-th (0 i N) comparison data D_{CMPi} is set as follows.

When S1>Vᵢ, D_{CMPi} is set to “1” (high level).

When 51<Vᵢ, D_{CMPi} is set to “0” (low level).

It should be noted that assignment of the high level and the low level may be inverted. In the present embodiment, the thresholds V₀ through V_{N} are located at constant intervals. It should be noted that the present invention is not restricted to such an arrangement. Such an arrangement in which the thresholds V₀ through V_{N} are located at constant intervals is not necessarily optimal, depending on the modulation method for processing the signal under test S1, and in such a case, the thresholds may be located at different intervals. That is to say, the thresholds V₀ through V_{N} should be set as appropriate according to the kind of the DUT 1, the modulation method, and so forth.

It should be noted that, in the present case, the comparison data D_{CMP0} through D_{CMPN} provides a so-called thermometer code, in which the value changes between 1 and 0 at a particular bit as the boundary (alternatively, the bit data is set to “all 0” or “all 1”). A set of (N+1) bits with the comparison data D_{CMP0} as the least significant bit and with the comparison data D_{CMPN} as the most significant bit will be collectively referred to as the “comparison code D_{CMP}” hereafter.

The number of thresholds, i.e., (N+1) should be set according to the modulation method for the signal under test S1. For example, in a case in which 16-QAM is employed, a dynamic range of around 4 bits (N=16) should be provided. In the case of other modulation methods, dynamic ranges of around 2 bits (N=4), 3 bits (N=8), or 5 bits (N=32) can be optimal.

The threshold level setting unit 14 generates the thresholds V₀ through V_{N}. For example, the threshold level setting unit 14 is a D/A converter, and generates each threshold which can be adjusted according to an external digital control signal. The thresholds may be dynamically controlled according to the kind of DUT 1, the modulation method, etc. Also, each threshold may be calibrated to a predetermined value beforehand.

In some communication protocols, amplitude fluctuation is allowable in the signal under test S1 from the DUT 1. Also, in some cases, DC offset fluctuation is allowable in the signal under test S1. In this case, the threshold level setting unit 14 may measure the amplitude or the DC offset of the signal under test S1, and may optimize the threshold values V₀ through V_{N} based upon the measurement results.

The time-to-digital converter 16 receives the comparison data D_{CMP0} through D_{CMPN} in increments of the thresholds V₀ through V_{N}, and generates the cross timing data D_{CRS0} through D_{CRSN} by measuring the timing at which each of the comparison data D_{CMP0} through D_{CMPN} changes. Description will be made in the present embodiment regarding an arrangement in which the cross timing data D_{CRS0} through D_{CRSN} are generated in increments of the thresholds. It should be noted that, in the most simple arrangement, single cross timing data D_{CRS} may be generated which indicates the timing at which at least one of the multiple comparison data D_{CMP} changes.

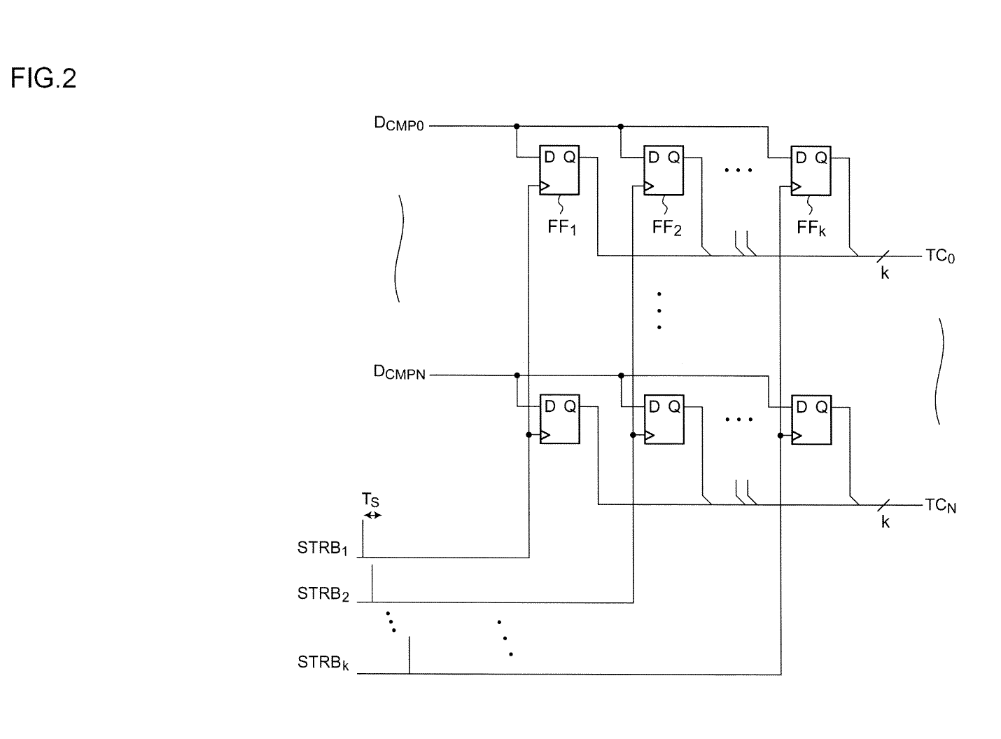

The time-to-digital converter 16 includes a latch array 18 and an encoder 20. FIG. 2 is a circuit diagram which shows an example configuration of the latch array 18.

The timing generator 22 generates K-phase (K represents an integer) multi-strobe signals STRB₁ through STRB_{K} in which the edge phases shift in increments of a predetermined sampling interval Ts. The sampling interval Ts is set according to the symbol rate (frequency) of the signal under test S1 or the modulation method. For example, the sampling interval Ts is obtained by multiplying the symbol period Tsym of the signal under test S1 (reciprocal of the symbol rate) by the reciprocal of an integer (e.g., 1/8). That is to say, the latch array 18 oversamples the comparison data D_{CMP0} through D_{CMPN} at a predetermined frequency.

The latch array 18 includes K flip-flops FF₁ through FF_{K} for each of the comparison data D_{CMP0} through D_{CMPN}. The i-th comparison data D_{CMPi} is input to the corresponding K flip-flops. The clock terminals of the K flip-flops receive respective K-phase multi-strobe signals STRB₁ through STRB_{K} as input signals. The output data of the flip-flops FF₁ through FF_{K} provides K-bit thermometer code (which will be referred to as the “timing code TC” hereafter). For example, the output of the FF₁ is assigned to the most significant bit (MSB), and the output of the FF_{K} is assigned to the least significant bit (LSB), for example.

The timing generator 22 may repeatedly generate the strobe signals STRB₁ through STRB_{K} with a test rate (frequency T_{RATE}) as a reference. An index (j) is assigned to the repeated test rate.

The i-th timing code TCᵢ indicates the timing at which the signal under test S1 crosses the i-th threshold Vᵢ. Specifically, when the transition point of the i-th timing code TCᵢ matches the upper L bit (1 L K) in the j-th test rate period, the cross timing (time elapsed from the start of the test) is obtained using the following Expression: t=j T_{RATE}+(L TS). The value L can be calculated by priority encoding the TCᵢ. The encoder 20 receives the timing code TC, and generates the cross timing data D_{CRS0} through D_{CRSN} which indicate the cross timing t. The data format of the cross timing data D_{CRS0} through D_{CRSN} is not restricted in particular. Also, the data format of the cross timing data may include the pair of values j and L.

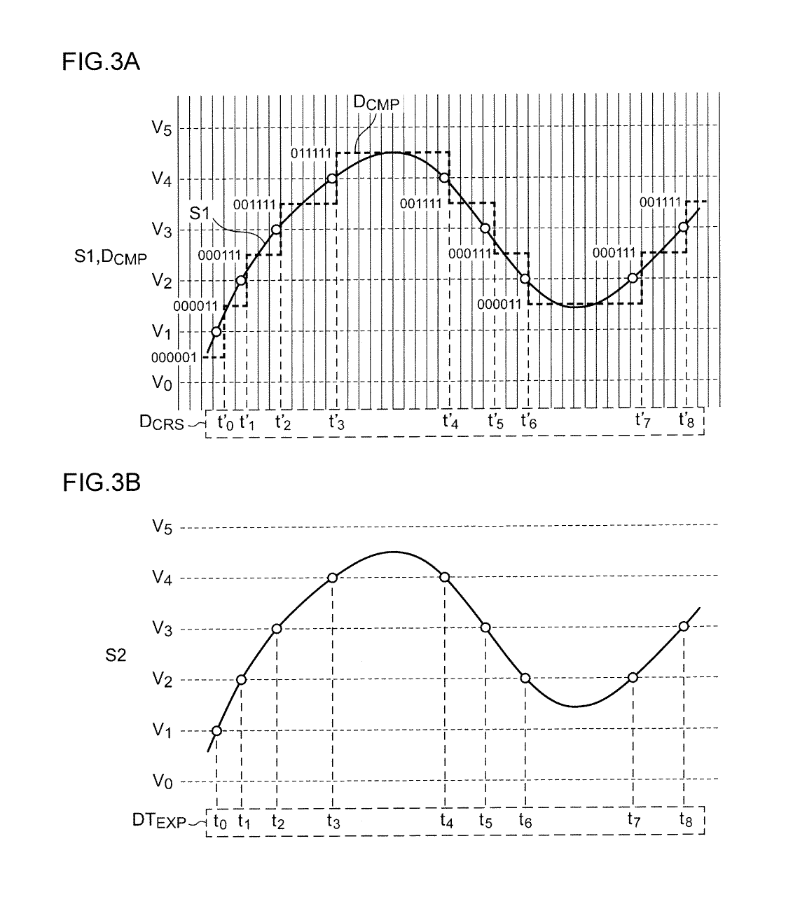

FIG. 3A is a time chart which shows the operation of the cross timing data generating unit 10. The solid line represents the signal under test S1, and the broken line represents the comparison code D_{CMP} digitized by the multi-value comparator 12. It should be noted that FIG. 3A shows an arrangement in which N=5.

Furthermore, the cross timing series t₀′ through t₈′ represents the timing of the change in the value of the comparison code D_{CMP}.

The above is the configuration and the operation of the cross timing data generating unit 10. It should be noted that the configuration of the cross timing data generating unit 10 is not restricted to the above-described arrangement. Also, the cross timing data generating unit may have other circuit configurations.

### (1-b) Expected Value Data Generating Unit

Next, returning to FIG. 1, description will be made regarding the expected value data generating unit 30.

The test apparatus 2 has information beforehand with respect to the pattern data based upon the signal under test S1 to be output from the DUT 1 is modulated. The pattern data thus held beforehand will be referred to as the “expected value” or “baseband expected value pattern”. The expected value pattern generator 32 generates a binary baseband expected value pattern PAT. The expected value pattern PAT is data that corresponds to a single symbol. In a case in which 16-QAM is employed, the expected value pattern PAT is provided as a 4-bit pattern. The number of bits of the expected value pattern PAT is set according to the modulation method.

A coding circuit 34 performs virtual digital multi-value modulation of the baseband expected value pattern PAT by means of digital signal processing in the same way as in the DUT 1, thereby generating an expected value waveform S2. Subsequently, the expected value pattern generator 32 compares the expected value waveform S2 which represents the expected signal for the signal under test S1 with the multiple thresholds V₀ through V_{N}, and generates, by means of digital signal processing, the timing expected value data DT_{EXP} which indicates the timing at which the expected value waveform S2 crosses each of the thresholds V₀ through V_{N}. FIG. 3B is a diagram which shows the expected value waveform S2, the thresholds V₀ through V_{N}, and the timing expected value data DT_{EXP}. The timing expected value data DT_{EXP} contains expected value cross timing t₀, t₁, and so on.

Furthermore, the coding circuit 34 outputs rate setting data RATE which represents the rate of the timing expected value data DT_{EXP}. The timing generator 22 receives the rate setting data RATE, and generates, synchronously with the rate clock, the strobe signals STRB containing a series of edges at intervals that correspond to the RATE.

### (1-c) Timing Comparison Unit

The timing comparison unit 40 compares the cross timing data D_{CRS}(t₀′, t₁′,) with the timing expected value data DT_{EXP}(t₀, t₁,) so as to judge the quality of the DUT 1 or to identify its defect.

If quantization error (in the time direction and the amplitude direction) is discounted, when the signal under test S1 is ideally generated, the measured cross timing data D_{CRS} matches the timing expected value data DT_{EXP}.

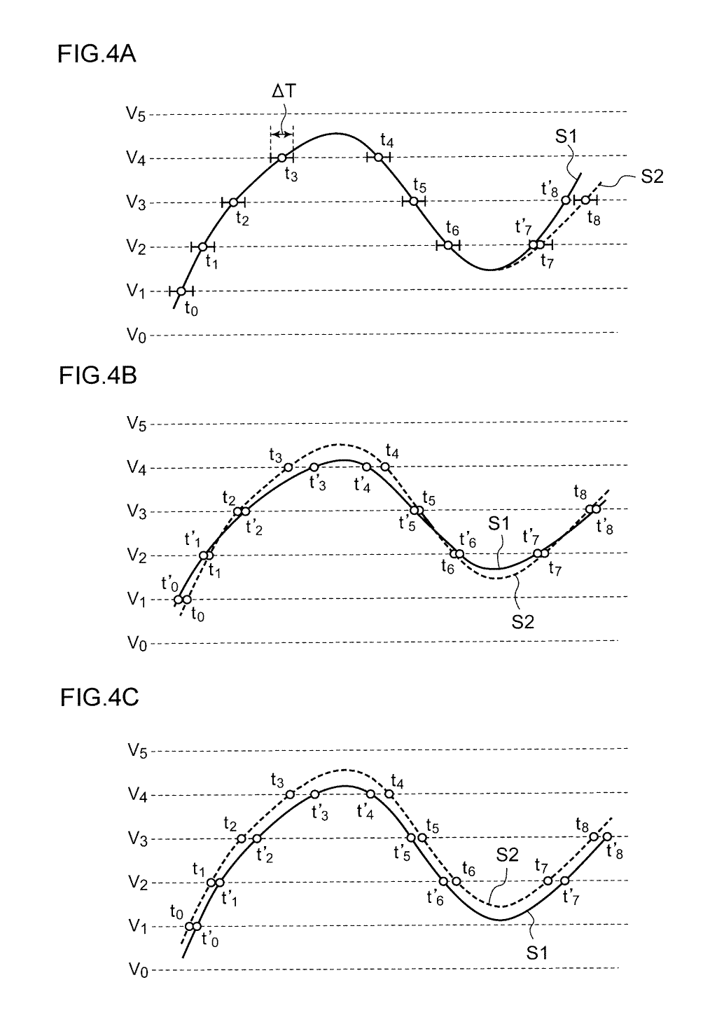

FIGS. 4A through 4C are diagrams which show an example of the comparison results obtained by the timing comparison unit 40.

In a case in which the measured cross timing data D_{CRS} exhibits a value that deviates from the range of permissible values T as compared with the timing expected value data DT_{EXP} due to waveform distortion or the like, judgment is made that the DUT 1 is defective. An arrangement should be made in which a window having an upper limit and a lower limit is provided for the expected value timing t, and judgment is made whether or not the cross timing t′ thus measured is within the window thus provided. In FIG. 4A, the cross timing t₈′ that corresponds to the threshold V₃ deviates from the range of expected values t₈.

FIG. 4B shows a situation in which amplitude degradation occurs in the signal under test S1 received from the DUT 1. FIG. 4C shows a situation in which DC offset occurs in the signal under test S1. The amplitude degradation and DC offset also lead to deviation of the measured cross timing t′ from the expected value timing t. Thus, the test apparatus 2 according to the embodiment is capable of detecting such defects.

### Second Embodiment

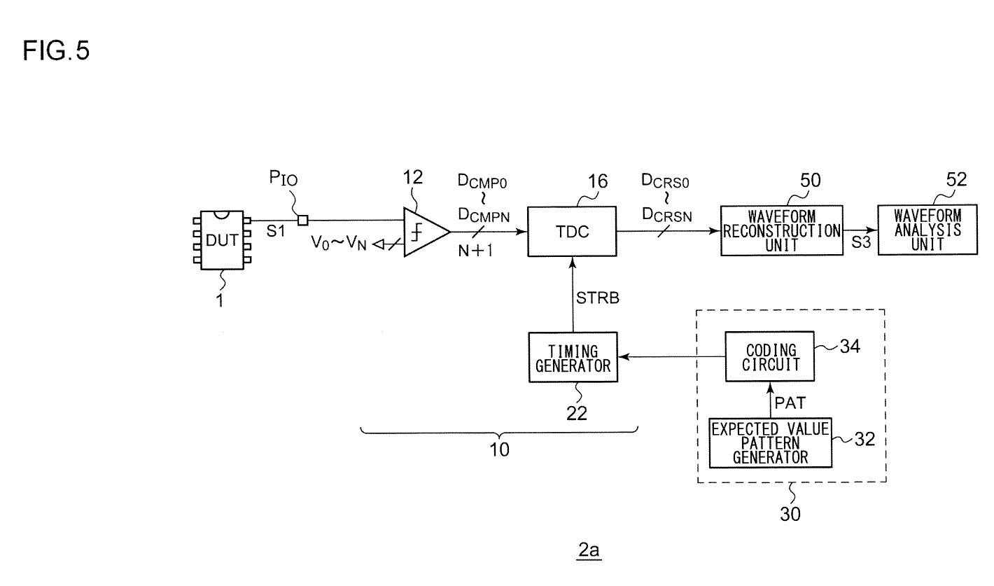

FIG. 5 is a block diagram which shows a configuration of a test apparatus 2a according to a second embodiment of the present invention. The test apparatus 2a includes a waveform reconstruction unit 50 and a waveform analysis unit 52, instead of or in addition to the timing comparison unit 40 according to the first embodiment. Description of the same blocks as those shown in FIG. 1 will be omitted.

The waveform reconstruction unit 50 receives the cross timing data D_{CRS0} through D_{CRSN} for the thresholds V₀ through V_{N}, respectively. The data represents the signal under test S1 in the form of the series (tₖ, Vᵢ). Here, k is an integer which represents a sampling index number. Furthermore, i (0 i N) represents an index number which indicates the level of the threshold. The waveform reconstruction unit 50 reconstructs the waveform of the signal under test S1 as digital values by performing interpolation in the time direction and the amplitude direction.

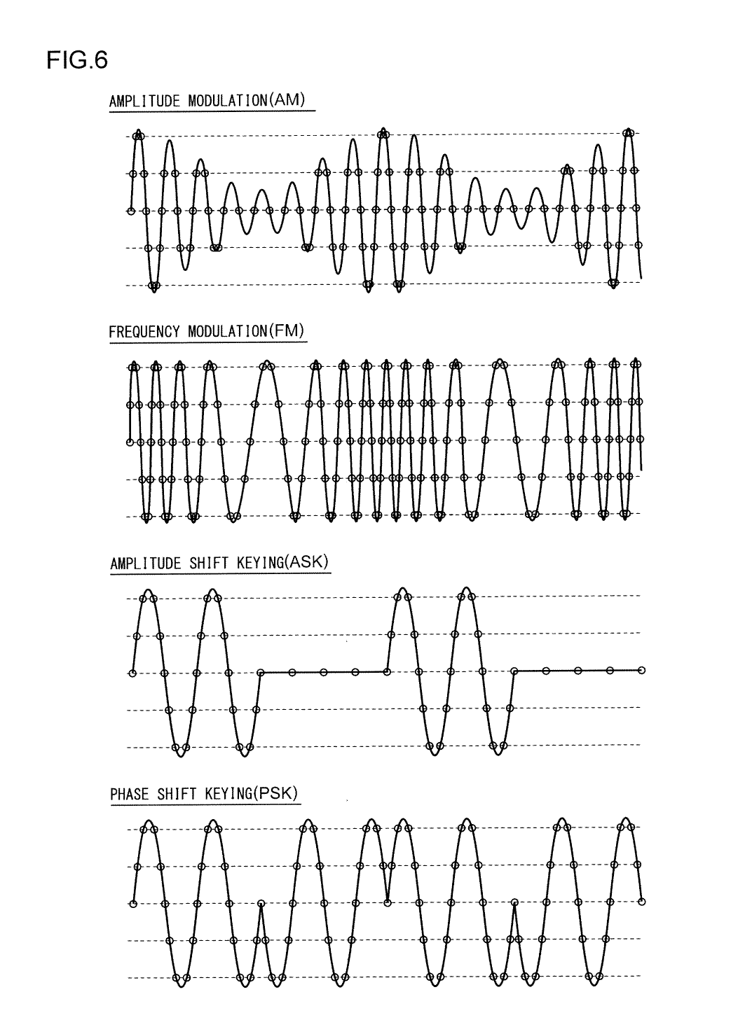

FIG. 6 is a diagram which shows sampling of various modulated waves performed by the cross timing data generating unit 10. In general, sampling is performed with the time axis direction as the reference, but in the present embodiment, sampling is performed with the thresholds V₀ through V_{N} located along the amplitude direction as the references.

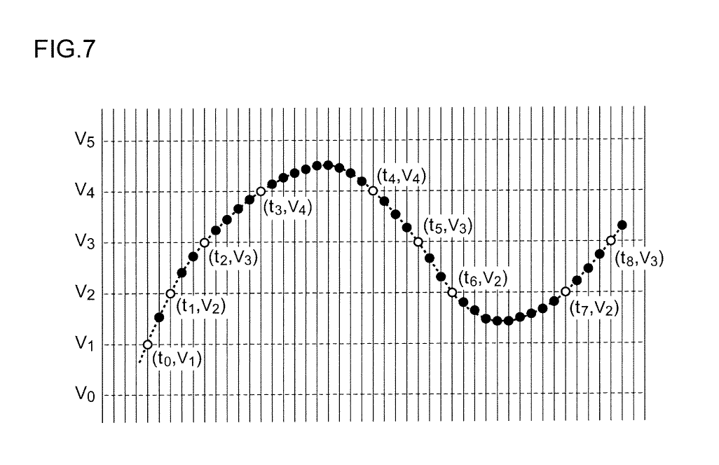

FIG. 7 is a diagram which shows the waveform reconstructed by the waveform reconstruction unit 50. Each open circle represents a point sampled with the threshold as a reference, and each solid circle represents an interpolated point. The waveform reconstruction unit 50 is a DSP (Digital Signal Processor) or a computer which is capable of executing signal processing such as linear interpolation, polynomial interpolation, cubic spline interpolation, etc. Taking into account the convenience of the signal processing performed in the downstream steps, the waveform reconstruction unit 50 preferably interpolates the cross timing data D_{CRS}, received in increments of the thresholds V, at constant intervals along the time axis direction. The waveform data S3 thus interpolated is input to the waveform analysis unit 52.

The waveform analysis unit 52 performs signal processing for the waveform data S3 thus reconstructed, and performs analysis and modulation analysis of the signal under test S1 in the time domain or the frequency domain of the signal under test S1. For example, after the waveform data S3 is converted into the frequency domain by performing a Fourier transform (Fast Fourier Transform, FFT), spectrum analysis or phase noise analysis (single side band phase noise spectrum analysis) may be performed on the signal under test S1. Also, in the time domain, eye diagram analysis or jitter analysis may be performed for the signal under test S1. Also, in a case in which the signal under test S1 is a modulated signal, a constellation map or the like may be created by applying modulation analysis to the waveform data S3.

With the test apparatus 2a shown in FIG. 5, time domain analysis, frequency domain analysis, and modulation analysis can be performed by the test apparatus 2a alone without the need to use a spectrum analyzer, digitizer, or the like.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

### (First Modification)

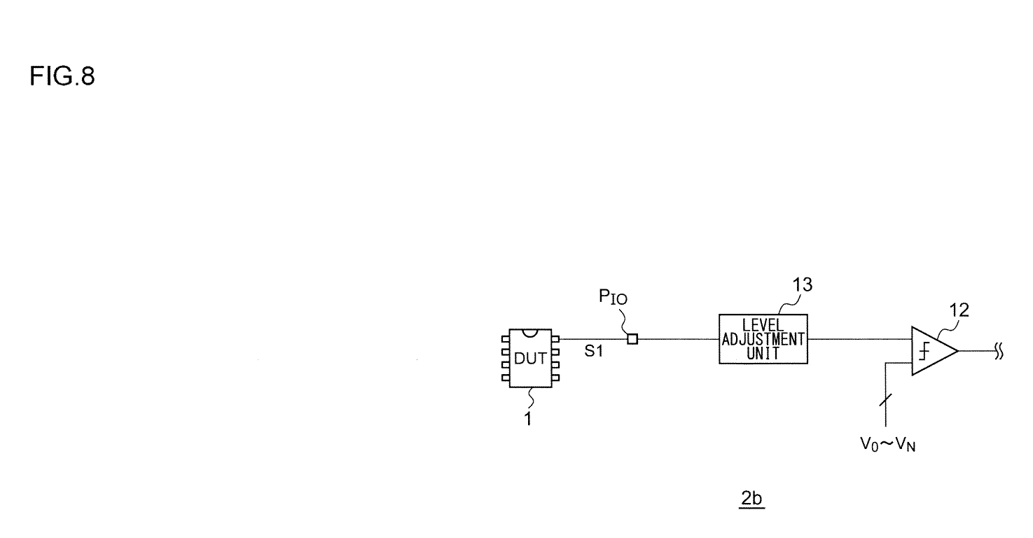

FIG. 8 is a block diagram which shows a part of the configuration of a test apparatus 2b according to a first modification. Such a modification can be applied to any one of the embodiments of the test apparatus 2 shown in FIG. 1 and the test apparatus 2a shown in FIG. 5. The components downstream of the multi-value comparator 12 are the same as those of the apparatuses shown in FIG. 1 or FIG. 5, or an apparatus configured as a combination thereof, and accordingly, the downstream components are not shown.

The test apparatus 2b includes a level adjustment unit 13 as a component upstream of the multi-value comparator 12. The level adjustment unit 13 has a function of changing at least one of the amplitude component of the signal under test S1 and the DC offset, and is configured as a variable attenuator, variable amplifier, or a level shifter, or is configured as a combination thereof. Also, an arrangement may be made in which the level adjustment unit 13 measures the peak voltage value, the amplitude, the DC offset, and so forth, and controls the attenuation rate, the gain, and the offset based upon the measurement results. The control operation may be performed using a so-called AGC (Automatic Gain Control) circuit.

In a case in which amplitude fluctuation or DC offset fluctuation is allowable in the signal under test S1, such a modification is capable of testing the DUT 1 while eliminating the effects of these factors.

### (Second Modification)

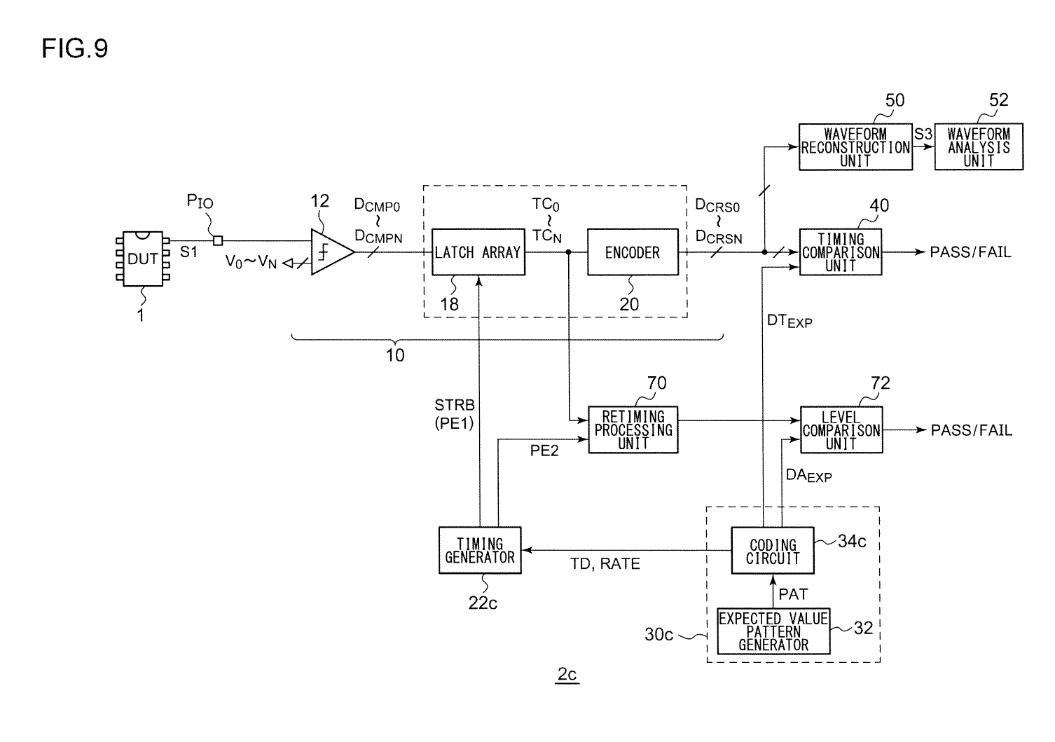

FIG. 9 is a block diagram which shows the configuration of a test apparatus 2c according to a second modification. The modification shown in FIG. 9 further includes a retiming processing unit 70 and a level comparison unit 72, in addition to the components shown in FIG. 1 or FIG. 5. As described above, the timing comparison unit 40 judges whether or not the timing at which the signal under test S1 crosses a predetermined threshold level matches the expected value timing. On the other hand, the level comparison unit 72 judges whether or not the amplitude level of the signal under test S1 at a given timing matches the expected value.

The expected value data generating unit 30c includes the expected value pattern generator 32 and a coding circuit 34c. The expected value pattern generator 32 generates an expected value pattern PAT which represents the expected value data to be output from the DUT 1.

Upon receiving the expected value pattern PAT, the coding circuit 34c generates amplitude expected value data DA_{EXP}, in addition to the timing expected value data DT_{EXP}, by coding the expected value pattern PAT thus received. The coding processing for the timing expected value data DT_{XEP} is performed in the same way as described above. The generation processing for the amplitude expected value data DA_{EXP} is executed as follows.

1. The target modulated signal waveform that corresponds to the expected value pattern PAT is quantized at predetermined sampling intervals. The quantization is virtual processing. The coding circuit 34c does not need to generate the actual target modulated signal waveform.

2. The amplitude expected value data DA_{EXP} is generated, which represents, for each sampling point, which of the multiple amplitude segments SEG₀ through SEG_{N+1} the amplitude level of the target modulated signal waveform belongs to.

The coding processing may be performed by reading out, from memory, the amplitude expected value data DA_{EXP} prepared beforehand, in increments of the expected value patterns PAT. Alternatively, the coding processing may be performed by numerical computation processing.

The multi-value comparator 12, the threshold level setting unit 14, the latch array 18, and the retiming processing unit 70 convert the signal under test S1 into a signal format which can be compared with the amplitude expected value data DA_{EXP}. In the present specification, this conversion processing will be referred to as “demodulation”, which differs from the ordinary demodulation processing in which a baseband signal is extracted by frequency mixing.

The multi-value comparator 12 compares the signal under test S1 with the thresholds V₀ through V_{N} which define the boundaries between the multiple amplitude segments SEG₀ through SEG_{N+1}, and generates multiple comparison data D_{CMP0} through D_{CMPN}.

The threshold level setting unit 14 sets the threshold levels for the multi-value comparator 12 according to the number of amplitude segments, the voltage range of the input signal under test S1, and the modulation method.

The latch array 18 operates in the same way as with the latch array 18 shown in FIG. 1 or FIG. 5. That is to say, the latch array 18 latches the comparison data D_{CMP0} through D_{CMPN} output from the multi-value comparator 12 in increments of predetermined sampling timings defined by the strobe signals STRB.

The data (which will be referred as the “judgment data” hereafter) TC₀ through TC_{N} thus latched by the latch array 18 represents, at each sampling timing, which of the amplitude segment identification numbers the signal under test S1 belongs to.

The retiming processing unit 70 receives the judgment data TC₀ through TC_{N} thus latched by the latch array 18. The retiming processing unit 70 performs retiming processing of the judgment data TC₀ through TC_{N} such that they match the rate of the amplitude expected value data DA_{EXP}, for the synchronization processing performed by the level comparison unit 72 provided as a downstream unit.

The coding circuit 34c outputs the timing data TD which indicates the sampling intervals, in addition to the amplitude expected value data DA_{EXP}. The timing generator 70 generates the strobe signals STRB containing a pulse edge sequence PE1 having pulse edges at intervals that correspond to the timing data TD.

The coding circuit 34c outputs rate setting data RATE which represents the rate of the amplitude expected value data DA_{EXP}. The timing generator 22c receives the rate setting data RATE, and generates a second pulse edge sequence PE2 having a frequency that corresponds to the rate setting data RATE. The retiming processing unit 70 synchronizes the multiple judgment data TC₀ through TC_{N} received from the latch array 18 with the timing of the second pulse edge sequence PE2.

The level comparison unit 72 receives the judgment data TC₀ through TC_{N} thus subjected to the retiming processing by the retiming processing unit 68 and the amplitude expected value data DA_{EXP}. The level comparison unit 72 judges whether or not the amplitude of the signal under test S1 output from the DUT 1 belongs to the expected amplitude segment.

The above is the configuration of the test apparatus 2c. Next, description will be made regarding the operation thereof.

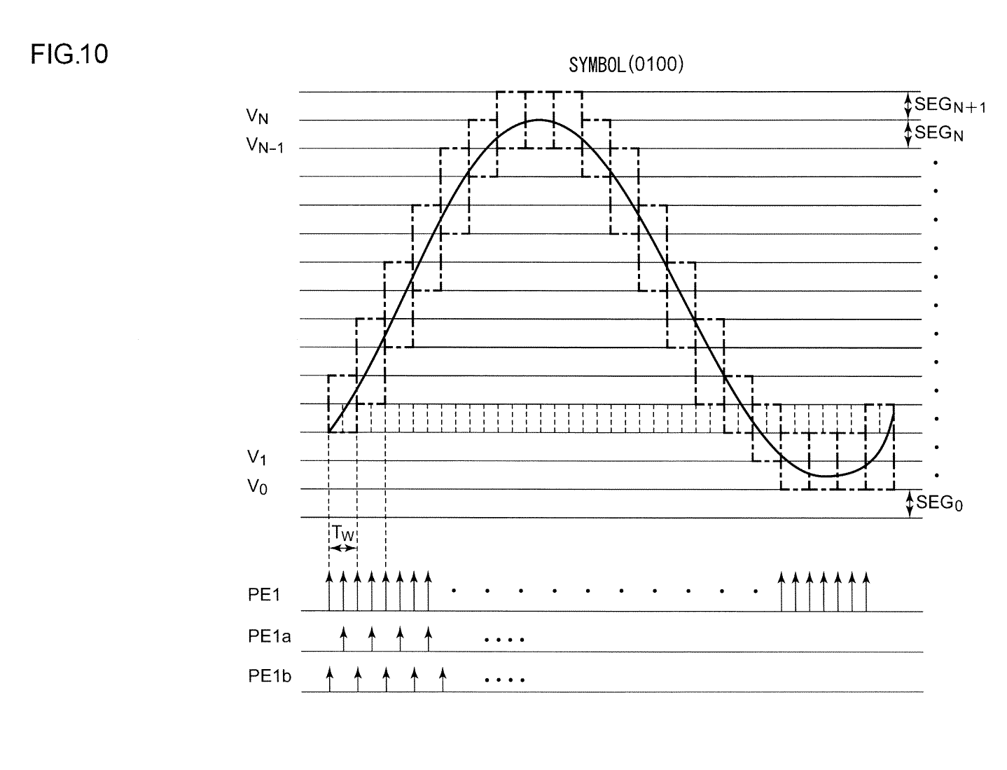

FIG. 10 is a conceptual diagram which shows the comparison processing performed by the level comparison unit 72 for making a comparison between the amplitude expected value data and the judgment data. In FIG. 10, the solid waveform represents the signal under test S1. The amplitude is divided into the multiple segments SEG₀ through SEG_{N+1}.

The alternately long and short dashed lines represent the target modulated signal waveform for an expected symbol, i.e., the window that corresponds to the expected value waveform S2, which is defined by the amplitude expected value data DA_{EXP}. In a case in which 16-QAM is employed, the coding circuit 34c outputs the amplitude expected value data DA_{EXP} which defines the windows that correspond to the 16 symbols. The window defined for each symbol should be set according to the modulation method, the coding method such as the gray coding method, the estimated margin of error for the amplitude, and the estimated margin of error for the phase. FIG. 10 shows the expected value window that corresponds to the symbol (0100).

The level comparison unit 72 makes a comparison between the amplitude expected value data DA_{EXP} which defines the window and the amplitude level of the signal under test S1 represented by the judgment data TC₀ through TC_{N}. Thus, judgment can be made whether or not the symbol of the signal under test S1 matches the expected value.

As with the pulse edges PE1a, a single sampling timing may be positioned at the center of the time width Tw of each window. Also, two sampling timings may be positioned at both ends of each window, as with the pulse edges PE1b. Such is the case for executing the window test as reported in the literature. Also, as with the pulse edges PE1, the frequency of the pulse edges may be set as high as possible so as to digitize the signal under test S1 at high resolution.

The above is the operation of the test apparatus 2c. With the test apparatus 2c, the signal under test S1 can be tested from both sides, i.e., both the time axis direction and the amplitude direction.

It should be noted that the configuration shown in FIG. 1 may further include the retiming processing unit 70 and the level comparison unit 72. Also, the configuration shown in FIG. 5 may further include the retiming processing unit 70 and the level comparison unit 72. Such configurations are also effective as the embodiments of the present invention.

### (Other Modifications)

In the embodiments, the type of transmission line that connects the DUT 1 and the test apparatus 2 is not restricted in particular, i.e., is not restricted to a wired connection or to a wireless connection. Also, the test apparatus according to the present embodiment can be used for various kinds of tests for various kinds of analog signals, in addition to a test for a modulated signal.

In general, the signal under test S1 output from the DUT 1 is generated synchronously with the internal rate clock of the test apparatus 2. In this case, the strobe signal (pulse edge sequence) STRB, which is supplied to the latch array 18 from the timing generator 22, may be generated synchronously with the rate clock.

In a case in which the signal under test S1 is generated asynchronously to the rate clock, an arrangement may be made in which preamble data is inserted at the top of the signal under test S1 as a training sequence, a base clock is reproduced using the training sequence, and the strobe signal STRB is generated synchronously with the base clock thus reproduced.

While the preferred embodiments of the present invention have been described using specific terms, such description is for illustrative purposes only, and it is to be understood that changes and variations may be made without departing from the spirit or scope of the appended claims.

What is claimed is:

1. A test apparatus which tests a modulated signal under test received from a device under test, the test apparatus comprising:
a cross timing measurement unit which generates cross timing data which indicates a timing at which the level of the signal under test crosses each of a plurality of thresholds;
an expected value data generating unit which generates timing expected value data that indicates a timing at which an expected value waveform of the signal under test crosses each of the plurality of thresholds when the expected value waveform is compared with each of the plurality of thresholds; and
a comparison unit which compares the cross timing data with the timing expected value data.

2. A test apparatus according to claim 1, wherein the cross timing measurement unit comprises:
a multi-value comparator which compares the level of the signal under test with each of the plurality of thresholds, and generates comparison data which represents a comparison result for each threshold; and
a time-to-digital converter which receives the comparison data for each threshold, and generates the cross timing data by measuring a timing at which the comparison data changes.

3. A test apparatus according to claim 2, wherein the time-to-digital converter comprises:
a latch array which performs, at a predetermined frequency, sampling of the comparison data output from the multi-value comparator; and
an encoder which generates the cross timing data based upon the latch data output from the latch array.

4. A test apparatus according to claim 1, further comprising a waveform reconstruction unit which receives the cross timing data for each threshold, and reconstructs the waveform of the signal under test by performing interpolation in the time direction and in the amplitude direction.

5. A test apparatus according to claim 4, wherein the waveform reconstruction unit interpolates, at constant intervals in the time axis direction, the cross timing data for each threshold.

6. A method for testing a modulated signal under test received from a device under test, the method comprising:
generating cross timing data which indicates a timing at which the level of the signal under test crosses each of a plurality of thresholds;
generating timing expected value data that indicates a timing at which an expected value waveform of the signal under test crosses each of the plurality of thresholds when the expected value waveform is compared with each of the plurality of thresholds; and
comparing the cross timing data with the timing expected value data.

7. A test apparatus which tests a modulated signal under test received from a device under test, the test apparatus comprising:
a cross timing measurement unit which generates cross timing data which indicates a timing at which the level of the signal under test crosses each of a plurality of thresholds; and
a waveform reconstruction unit which receives the cross timing data for each threshold, and reconstructs the waveform of the signal under test by performing interpolation in the time direction and in the amplitude direction.

8. A test apparatus according to claim 7, further comprising a waveform analysis unit which analyzes the waveform of the signal under test reconstructed by the waveform reconstruction unit.

9. A test apparatus according to claim 7, wherein the waveform reconstruction unit interpolates the cross timing data for each threshold at constant intervals in the time-axis direction.

10. A method for testing a modulated signal under test received from a device under test, the method comprising:
generating cross timing data which indicates a timing at which the level of the signal under test crosses each of a plurality of thresholds;
reconstructing the waveform of the signal under test by interpolating the cross timing data for each threshold in the time direction and in the amplitude direction.
